(19) United States
(12) Patent Application Publication
(10) Pub. No.: US 2019/0285927 A1
(43) Pub. Date: Sep. 19, 2019

(54) LIQUID CRYSTAL PANEL AND MANUFACTURING METHOD THEREOF

(71) Applicants: Beijing BOE Optoelectronics Technology Co., Ltd., Beijing (CN); BOE TECHNOLOGY GROUP CO., LTD., Beijing (CN)

(72) Inventors: Xiaoqing Peng, Beijing (CN); Kaixuan Wang, Beijing (CN); Ruichen Zhang, Beijing (CN); Dong Liang, Beijing (CN)

(21) Appl. No.: 16/335,218

(22) PCT Filed: Apr. 13, 2018
(86) PCT No.: PCT/CN2018/082948

§ 371 Date: Mar. 20, 2019

(30) Foreign Application Priority Data
Jun. 5, 2017 (CN) 201710415158.9

(51) Int. Cl. G02F 1/1339

(52) U.S. Cl. CPC G02F 1/13394; G02F 1/133512; G02F 2001/13396

(57) ABSTRACT

The present disclosure relates to a liquid crystal panel and a method of preparing the same. The liquid crystal panel includes a first substrate, a second substrate opposite to the first substrate, and a liquid crystal layer formed between the first substrate and the second substrate. The liquid crystal panel includes a first photo spacer, formed on the first substrate and extending along a first direction. The liquid crystal panel includes a second photo spacer, formed on the second substrate and opposite to the first photo spacer and extending along a second direction.

### CROSS REFERENCE OF RELATED APPLICATIONS

The present application is based upon International Application No. PCT/CN2018/082948, filed on Apr. 13, 2018, which is based upon and claims the priority of Chinese Patent Application No. 201710415158.9, filed on Jun. 5, 2017, and the entire contents thereof are incorporated herein by reference as part of the present application.

### TECHNICAL FIELD

The present disclosure relates to a liquid crystal panel and a method of preparing the same, and more particularly, to a liquid crystal panel capable of preventing damage of an alignment layer and a method of preparing the same.

### BACKGROUND

In recent years, various liquid crystal panels have been developed. In a liquid crystal panel, liquid crystals are included between two substrates. Alignment layers (PI) are respectively formed on the two substrates, such that liquid crystal molecules have an initial orientation. The liquid crystal molecules change the orientation under the action of an electric field, thus changing a light transmittance of the liquid crystal panel and/or changing a propagation direction of light passing through the liquid crystal panel. Therefore, the liquid crystal panel may be used to form a liquid crystal display panel, a liquid crystal lens panel, or the like.

In order to maintain a distance between the two substrates of the liquid crystal panel to form a space for filling the liquid crystal, a photo spacer (PS) is usually formed between the two substrates of the liquid crystal panel. The PS is usually a polymer having elasticity. For example, in a liquid crystal display panel, a bottom portion of the PS may be formed in a region where a black matrix (BM) at a color filter (CF) substrate side is located, and an upper portion of the PS may be propped on a thin film transistor (TFT) at an array substrate side.

It should be noted that the information disclosed in the foregoing background section is only for enhancement of understanding of the background of the present disclosure and therefore may include information that does not constitute related art that is already known to those of ordinary skill in the art.

### SUMMARY

According to an aspect of the present disclosure, there is provided a liquid crystal panel. The liquid crystal panel includes a first substrate, a second substrate opposite to the first substrate, and a liquid crystal layer formed between the first substrate and the second substrate. The liquid crystal panel includes a first photo spacer formed on the first substrate and extending along a first direction. The liquid crystal panel includes a second photo spacer formed on the second substrate and opposite to the first photo spacer and extending along a second direction.

In some arrangements, the first photo spacer is in contact with but not connected to the second photo spacer.

In some arrangements, respective portions of the first photo spacer and the second photo spacer that are in contact with each other slide along an extending direction of at least one of the first photo spacer and the second photo spacer.

In some arrangements, at least one of the first photo spacer and the second photo spacer is formed discontinuously. A portion where the first photo spacer is in contact with the second photo spacer is able to slide along an extending direction of at least one of the first photo spacer and the second photo spacer within an extending range of the first photo spacer and the second photo spacer.

In some arrangements, portions of the first photo spacer and the second photo spacer respectively in contact with the first substrate and the second substrate have flat surfaces.

In some arrangements, the first photo spacer includes a plurality of first photo spacers, and the plurality of first photo spacers has an identical height.

In some arrangements, the second photo spacer includes a plurality of second main photo spacers and a plurality of second auxiliary photo spacers. A height of each of the second auxiliary photo spacers is smaller than height of each of the second main photo spacers.

In some arrangements, the first substrate includes a plurality of data lines and gate lines intersecting with each other, and the first photo spacer is formed on a location of the first substrate corresponding to the data line.

In some arrangements, the second substrate includes a black matrix corresponding to the data line and the gate line, and the second photo spacer is formed on the black matrix corresponding to the gate line.

According to another aspect of the present disclosure, there is provided a method of preparing a liquid crystal panel. The method includes forming a first photo spacer extending along a first direction on a first substrate. The method includes forming a second photo spacer extending along a second direction on a second substrate. The method includes forming a cell assembly by the first substrate and the second substrate. The first photo spacer and the second photo spacer are opposite with each other, such that a certain distance exists between the first substrate and the second substrate. The method includes filling a liquid crystal material between the first substrate and the second substrate.

In some arrangements, forming a cell assembly by the first substrate and the second substrate further includes causing the first photo spacer to be in contact with but not connected to the second photo spacer.

According to another aspect of the present disclosure, there is provided a liquid crystal display device. The liquid crystal display device includes the liquid crystal panel according to above aspects of the present disclosure.

According to another aspect of the present disclosure, there is provided a liquid crystal lens. The liquid crystal lens includes the liquid crystal panel according to above aspects of the present disclosure.

It should be noted that, the above general description and following detailed description are illustrative and explanatory only but not restrictive to the present disclosure.

This section provides an overview of various implementations or examples of the techniques described in the present disclosure, and is not a comprehensive disclosure of all scopes or all features of the disclosed technology.

### BRIEF DESCRIPTION OF THE DRAWINGS

The accompanying drawings herein are for providing a further understanding of the present disclosure and constitute a part of the specification, and together with following detailed description, to explain the present disclosure, but not to be construed as limiting the present disclosure. In the drawing:

FIG. 1 is a schematic view of a first substrate formed with a first photo spacer according to an arrangement of the present disclosure;

FIG. 2 is a schematic view of a second substrate formed with a second photo spacer according to an arrangement of the present disclosure;

FIG. 3 is a schematic view of a first photo spacer and a second photo spacer after the first substrate and the second substrate are formed a cell assembly according to an arrangement of the present disclosure;

FIG. 4 is a schematic view showing a state in which a liquid crystal panel is forced to cause a first photo spacer and a second photo spacer to relatively slide according to an arrangement of the present disclosure; and

FIG. 5 is a flow chart of a method of preparing a liquid crystal panel according to an arrangement of the present disclosure.

### DETAILED DESCRIPTION

In order to make those skilled in the art better understand the technical solutions of the present disclosure, a liquid crystal panel and a preparation method thereof provided by the present disclosure are further described in detail below with reference to the accompanying drawings and specific arrangements.

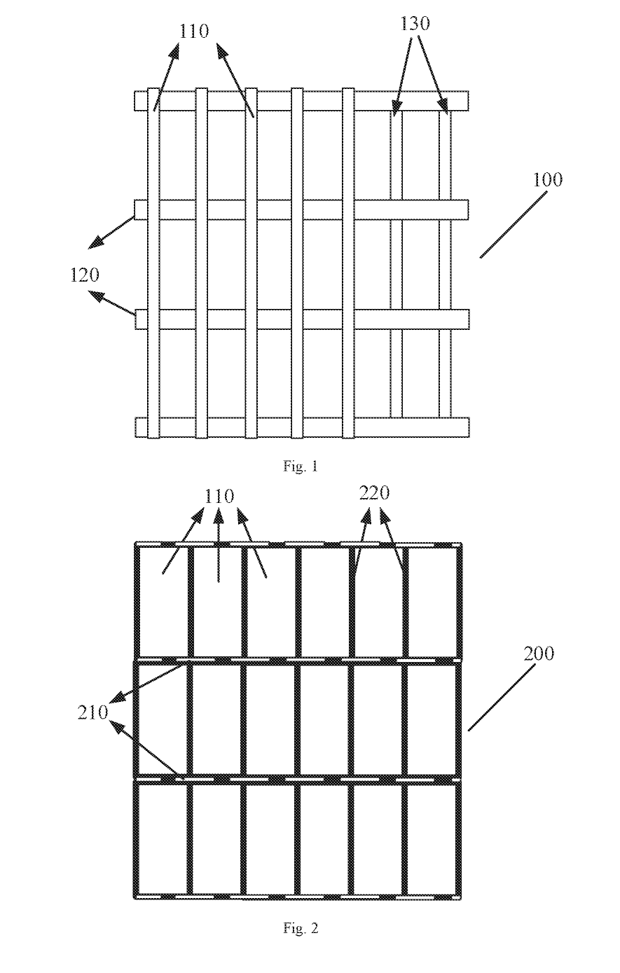

FIG. 1 is a schematic view of a first substrate formed with a first photo spacer according to an arrangement of the present disclosure; FIG. 2 is a schematic view of a second substrate formed with a second photo spacer according to an arrangement of the present disclosure; FIG. 3 is a schematic view of a first photo spacer and a second photo spacer after the first substrate and the second substrate are formed a cell assembly according to an arrangement of the present disclosure. Referring to FIG. 1 to FIG. 3, a liquid crystal panel according to an arrangement of the present disclosure may include: a first substrate 100, a second substrate 200 opposite to the first substrate 100, and a liquid crystal layer (not shown) formed between the first substrate 100 and the second substrate 200; a first photo spacer 110, formed on the first substrate 100 and extending along a first direction; and a second photo spacer 210, formed on the second substrate 300, opposite to the first photo spacer 110 and extending along a second direction.

In this arrangement, as shown in FIG. 1 and FIG. 2, the first substrate 100 may be an array substrate formed with gate lines 120 and data lines 130, and the second substrate 200 may be a color film substrate formed with a black matrix 220 and a color filter 230. However, the present disclosure is not limited thereto, and the first substrate 100 and the second substrate 200 may be other substrates for forming a liquid crystal panel.

In the present arrangement, the first direction and the second direction may be perpendicular to each other, and the first direction may be a column direction shown in the drawing, and the second direction may be a row direction shown in the drawing. However, the present disclosure is not limited thereto. Depending on a specific arrangement of the liquid crystal panel, the first direction and the second direction may have other angles other than 90 degrees, and the first direction and the second direction are not limited to the row direction and column direction. For example, when the liquid crystal panel has a wiring structure and/or a light shielding structure along other directions such as a diagonal direction, the first photo spacer 110 and the second photo spacer 210 may be disposed along these directions.

According to the present arrangement, the first photo spacer 110 and the second photo spacer 210 are in contact with each other but are not connected. Specifically, when the first substrate 100 and the second substrate 200 are opposed to each other to form a liquid crystal cell structure, the first photo spacer 110 and the second photo spacer 210 are in contact with each other, thus supporting the first substrate 100 and the second substrate 200, to maintain a predetermined distance between the first substrate 100 and the second substrate 200.

For example, as shown in FIG. 1, the first substrate 100 includes a plurality of data lines 130 and gate lines 120 that intersect with each other. The data line 130 extends along a vertical direction (column direction), and the gate line 120 extends along a horizontal direction (row direction). As shown in FIG. 1, the first photo spacer 110 is formed on the data line 130. As shown in FIG. 1, for convenience of illustration, no first photo spacer 110 is formed on two rightmost data lines 130. However, the arrangement is not limited thereto, the first photo spacer 110 may also be formed on the two rightmost data lines 130.

In addition, as shown in FIG. 2, the second substrate 200 includes black matrixes 220 corresponding to the data lines 130 and the gate lines 120. In the liquid crystal panel, the black matrix 220 may block light, thus preventing a user from seeing wiring and other circuit structures in the liquid crystal panel, which may improve a contrast ratio. The second photo spacer 210 is formed on a portion of the black matrix 220 corresponding to the gate line.

In the present arrangement, the description of “A is formed on B” may mean that A is directly formed on B, or one or more intermediate structures may be formed between A and B. For example, the first photo spacer 110 being formed on the data line 130 may mean that the first photo spacer 110 is directly formed on the data line 130, and may also mean that the first photo spacer 110 is formed above the data line 130 and one or more intermediate structures are formed between the first photo spacer 110 and the data line 130.

Referring to FIGS. 1 and 2, the first photo spacer 110 is formed as a continuous straight line, and the second photo spacer 210 is formed as a discontinuous straight line. However, the present disclosure is not limited thereto. The first photo spacer 110 and the second photo spacer 210 may be formed as any one of a continuous straight line and/or a discontinuous straight line. In addition, the specific shape of the first photo spacer 110 and the second photo spacer 210 is not limited to a straight line. The first photo spacer 110 and the second photo spacer 210 may have other shapes according to actual needs.

In one arrangement, portions of the first photo spacer 110 and the second photo spacer 210 respectively in contact with the first substrate 100 and the second substrate 200 may have flat surfaces. In this case, the first photo spacer 110 and the second photo spacer 210 may be in close contact with the first substrate 100 and the second substrate 200, respectively, thus facilitating firmly forming the first photo spacer 110 and the second photo spacer on the first substrate 100 and the second substrate 200. In addition, due to flat surfaces of the first photo spacer 110 and the second photo spacer 210, a thickness of the liquid crystal cell can be prevented from changing during sliding caused by a pressing force, thus avoiding generation of defects such as water ripples.

The first photo spacer may include a plurality of first photo spacers, and the plurality of first photo spacers has an identical height. For example, corresponding to the plurality of data lines 130, a plurality of first photo spacers 110 may be formed, and these first photo spacers 110 have the same height.

In another aspect, the second photo spacer 210 may include a plurality of second main photo spacers and a plurality of second auxiliary photo spacers (not shown), and a height of the second auxiliary photo spacer may be smaller than that of the second main photo spacer. In this case, since the first photo spacers 110 have the same height and the second photo spacers 210 include a plurality of second main photo spacers and a plurality of second auxiliary photo spacers having different heights, the photo spacers obtained by bringing the first photo spacer 110 and the second photo spacer 210 into contact with each other have different heights as a whole. Therefore, it can ensure that liquid crystals in the liquid crystal cell have a certain range of fluctuations up and down, thus facilitating generation of defects such as Mura.

The portions where the first photo spacer 110 and the second photo spacer 210 are in contact are not connected to each other. That is, the first photo spacer 110 and the second photo spacer 210 are not formed integrally with each other, so that they may be movable relative to each other. More specifically, the portion where the first photo spacer 110 and the second photo spacer 210 are in contact may slide along the extending direction of the first photo spacer 110 and/or the second photo spacer 210.

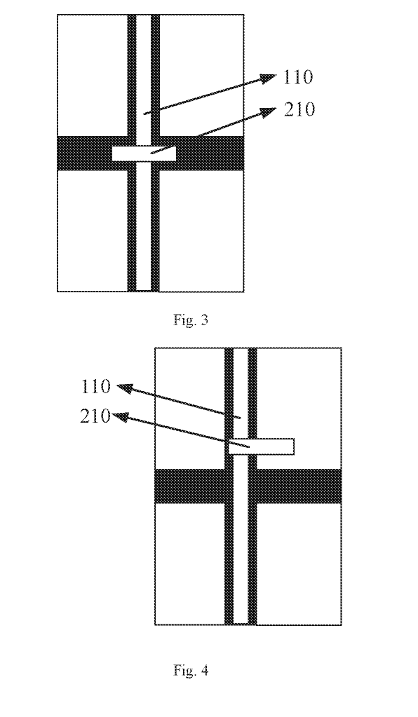

In this case, when the liquid crystal panel is subjected to an external force, the sliding occurs between the portions where the first photo spacer 110 and the second photo spacer 210 are in contact with each other. For example, FIG. 4 shows a schematic view of a state in which a liquid crystal panel is subjected to a force to cause a first photo spacer and a second photo spacer to relatively slide according to an arrangement of the present disclosure. The second photo spacer 210 and the first photo spacer 110 relatively slid relative to each other along the first direction and the second direction, such that the second photo spacer 210 enters an area corresponding to a red color filter (corresponding to an area of the red sub-pixels, i.e. an area in which an alignment layer is formed) as shown in FIG. 4. However, since the second photo spacer 210 is formed on the second substrate 200, it will not move with respect to the second substrate 200. On the other hand, a free end of the second photo spacer 210 and the first photo spacer 110 are in contact with each other. Therefore, the second photo spacer 210 will not contact the first substrate 100 because it is raised by the first photo spacer 110. Thus, even if the second photo spacer 210 slides to the area corresponding to the red color filter (corresponding to the area of the red sub-pixels, i.e. the area in which the alignment layer is formed), the free end of the second photo spacer 210 will not contact with the first substrate 100 and/or the second substrate 200 to scratch the first substrate 100 and/or the second substrate 200.

Therefore, the liquid crystal panel of the present arrangement can prevent the movement of the photo spacer from causing scratching of the alignment layer on the substrate. In addition, as explained above, even if the photo spacer moves to the region where the alignment layer is formed, the alignment layer will not be damaged, so that it is not necessary to form a large region of the black matrix, thus facilitating the aperture ratio of the liquid crystal panel.

According to this arrangement, the liquid crystal panel includes: a first substrate, a second substrate opposite to the first substrate, and a liquid crystal layer formed between the first substrate and the second substrate; a first photo spacer, formed on the first substrate and extending along a first direction; and a second photo spacer, formed on the second substrate, opposite to the first photo spacer and extending along a second direction. According to the liquid crystal panel of the present disclosure, it may prevent movement of the photo spacer from causing scratching of an alignment layer on the substrate, and it facilitates increasing an aperture ratio and prevents generation of water ripple.

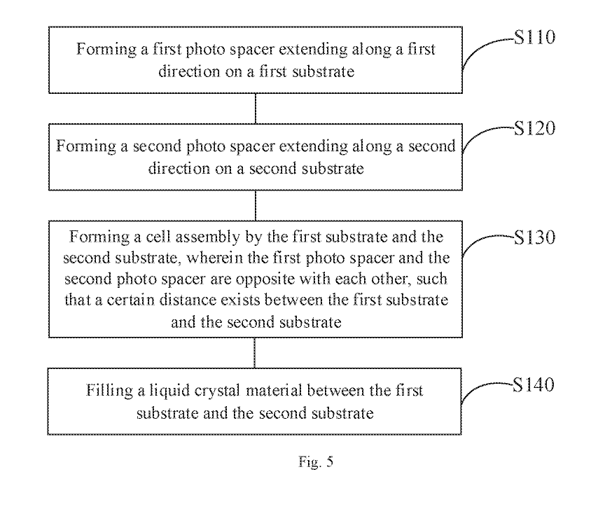

FIG. 5 is a flow chart of a method of preparing a liquid crystal panel according to an arrangement of the present disclosure. Referring to FIG. 5, a method of preparing a liquid crystal panel according to an arrangement of the present disclosure may include: block 5110, forming a first photo spacer extending along a first direction on a first substrate; block 5120, forming a second photo spacer extending along a second direction on a second substrate; and block 5130, forming a cell assembly by the first substrate and the second substrate. The first photo spacer and the second photo spacer are opposite with each other, such that a certain distance exists between the first substrate and the second substrate. The method may include block 5140, filling a liquid crystal material between the first substrate and the second substrate.

According to an arrangement, in the process of making the first photo spacer and the second photo spacer opposite to each other in block 5130, the first photo spacer and the second photo spacer may be brought into contact with each other but not connected. For other specific details of the above method, reference may be made to the description of the liquid crystal panel in the foregoing arrangement, and thus will not be described herein.

According to this arrangement, a method of preparing a liquid crystal panel includes forming a first photo spacer extending along a first direction on a first substrate. The method includes forming a second photo spacer extending along a second direction on a second substrate. The method includes forming a cell assembly by the first substrate and the second substrate. The first photo spacer and the second photo spacer are opposite with each other, such that a certain distance exists between the first substrate and the second substrate. The method includes filling a liquid crystal material between the first substrate and the second substrate. According to the liquid crystal panel prepared according to the method of the present disclosure, it may prevent movement of the photo spacer from causing scratching of an alignment layer on the substrate, and it facilitates increasing an aperture ratio and prevents generation of water ripple.

Another arrangement of the present disclosure provides a liquid crystal display device including a liquid crystal panel according to the foregoing arrangement of the present disclosure. The specific manner of constructing the liquid crystal display device using the liquid crystal panel according to the foregoing arrangements of the present disclosure is well known to those skilled in the art, and thus these specific manners will be omitted herein for the sake of brevity.

According to the present arrangement, the liquid crystal display device includes the liquid crystal panel according to the present disclosure, and thus it may prevent movement of the photo spacer from causing scratching of an alignment layer on the substrate, and it facilitates increasing an aperture ratio and prevents generation of water ripple.

Yet another arrangement of the present disclosure provides a liquid crystal lens including a liquid crystal panel according to the foregoing arrangement of the present disclosure. The specific manner of constructing the liquid crystal lens using the liquid crystal panel according to the foregoing arrangements of the present disclosure is well known to those skilled in the art, and thus these specific manners will be omitted herein for the sake of brevity.

According to the present arrangement, the liquid crystal lens includes the liquid crystal panel according to the present disclosure, and thus it may prevent movement of the photo spacer from causing scratching of an alignment layer on the substrate, and it facilitates increasing an aperture ratio and prevents generation of water ripple.

It is to be understood that the above arrangements are merely exemplary arrangements employed to explain the principles of the present disclosure, but the present disclosure is not limited thereto. Various modifications and improvements can be made by those skilled in the art without departing from the spirit and scope of the present disclosure, and such modifications and improvements are also considered to be within the scope of the present disclosure.

1. A liquid crystal panel, comprising:
a first substrate, a second substrate opposite to the first substrate, and a liquid crystal layer formed between the first substrate and the second substrate;
a first photo spacer, formed on the first substrate and extending along a first direction; and
a second photo spacer, formed on the second substrate, opposite to the first photo spacer and extending along a second direction.

2. The liquid crystal panel according to claim 1, wherein the first photo spacer is in contact with but not connected to the second photo spacer.

3. The liquid crystal panel according to claim 2, wherein respective portions of the first photo spacer and the second photo spacer that are in contact with each other slide along an extending direction of at least one of the first photo spacer and the second photo spacer.

4. The liquid crystal panel according to claim 1, wherein portions of the first photo spacer and the second photo spacer respectively in contact with the first substrate and the second substrate have flat surfaces.

5. The liquid crystal panel according to claim 1, wherein the first photo spacer comprises a plurality of first photo spacers, and the plurality of first photo spacers has an identical height.

6. The liquid crystal panel according to claim 5, wherein the second photo spacer comprises a plurality of second main photo spacers and a plurality of second auxiliary photo spacers, and a height of each of the second auxiliary photo spacers is smaller than a height of each of the second main photo spacers.

7. The liquid crystal panel according to claim 1, wherein the first substrate comprises a plurality of data lines and gate lines intersecting with each other, and the first photo spacer is formed on a location of the first substrate corresponding to one of the data lines.

8. The liquid crystal panel according to claim 7, wherein the second substrate comprises a black matrix corresponding to the data lines and the gate lines, and the second photo spacer is formed on the black matrix corresponding to one of the gate lines.

9. A method of preparing a liquid crystal panel, comprising:
forming a first photo spacer extending along a first direction on a first substrate;
forming a second photo spacer extending along a second direction on a second substrate;
forming a cell assembly by the first substrate and the second substrate, wherein the first photo spacer and the second photo spacer are opposite with each other, such that a certain distance exists between the first substrate and the second substrate; and
filling a liquid crystal material between the first substrate and the second substrate.

10. The method according to claim 9, wherein forming a cell assembly by the first substrate and the second substrate further comprises: causing the first photo spacer to be in contact with but not connected to the second photo spacer.

11. The method according to claim 10, wherein respective portions of the first photo spacer and the second photo spacer that are in contact with each other slide along an extending direction of at least one of the first photo spacer and the second photo spacer.

12. The method according to claim 9, wherein portions of the first photo spacer and the second photo spacer respectively in contact with the first substrate and the second substrate have flat surfaces.

13. The method according to claim 9, wherein the first photo spacer comprises a plurality of first photo spacers, and the plurality of first photo spacers has an identical height.

14. The method according to claim 13, wherein the second photo spacer comprises a plurality of second main photo spacers and a plurality of second auxiliary photo spacers, and a height of each of the second auxiliary photo spacers is smaller than a height of each of the second main photo spacers.

15. The method according to claim 9, wherein the first substrate comprises a plurality of data lines and gate lines intersecting with each other, and the first photo spacer is formed on a location of the first substrate corresponding to one of the data lines.

16. The method according to claim 15, wherein the second substrate comprises a black matrix corresponding to the data line and the gate line, and the second photo spacer is formed on the black matrix corresponding to one of the gate lines.

17. A liquid crystal display device, comprising the liquid crystal panel according to claim 1.

18. A liquid crystal lens, comprising the liquid crystal panel according to claim 1.

19. The liquid crystal panel according to claim 2, wherein at least one of the first photo spacer and the second photo spacer is formed discontinuously, and respective portions of the first photo spacer and the second photo spacer that are in contact with each other slide along an extending direction of at least one of the first photo spacer and the second photo spacer within an extending range of the first photo spacer and the second photo spacer.

20. The method according to claim 10, wherein at least one of the first photo spacer and the second photo spacer is formed discontinuously, and respective portions of the first photo spacer and the second photo spacer that are in contact with each other slide along an extending direction of at least one of the first photo spacer and the second photo spacer within an extending range of the first photo spacer and the second photo spacer.
